(19) United States
(12) Patent Application Publication
(10) Pub. No.: US 2014/0101345 A1
(43) Pub. Date: Apr. 10, 2014

(54) UNIVERSAL SERIAL BUS (USB) PLUG-IN EVENT DETECTION SYSTEM AND ASSOCIATED METHOD

(71) Applicant: ANALOG DEVICES, INC., Norwood, MA (US)

(72) Inventor: Steven W. Ranta, Seattle, WA (US)

(73) Assignee: ANALOG DEVICES, INC., Norwood, MA (US)

(21) Appl. No.: 14/010,612

(22) Filed: Aug. 27, 2013

Related U.S. Application Data
(60) Provisional application No. 61/711,203, filed on Oct. 8, 2012.

(51) Int. Cl. G06F 11/30

(52) U.S. Cl. CPC G06F 11/3051
USPC 710/16

(57) ABSTRACT

Universal serial bus (USB) plug-in event detection systems and methods are disclosed herein. An exemplary USB system includes a USB interface and a USB capacitive-sensing detection module coupled with a data line of the USB interface. The USB capacitance-sensing detection module monitors a change in capacitance on the data line to detect USB plug-in events. USB capacitance-sensing detection module can detect a USB plug-in event when the USB interface is in a powered-down state. The USB system can be configured to power up the USB interface upon detecting the USB plug-in event. The USB system can further include a USB host. The USB host can be in a standby or hibernation mode (minimum power state) when the USB capacitive-sensing detection module detects the USB plug-in event, and the USB system can be configured to wake-up the USB host from the standby or hibernation mode upon detecting the USB plug-in event.

This application is a non-provisional application of U.S. Provisional Patent Application Ser. No. 61/711,203, filed Oct. 8, 2012, which is hereby incorporated by reference in its entirety.

### TECHNICAL FIELD

The present disclosure relates generally to universal serial buses (USBs), and more particularly, to USB plug-in event detection systems and associated methods.

### BACKGROUND

Universal Serial Bus (USB) supports data exchange between various devices. A USB system typically includes a USB host, a USB device, and a USB interconnect. The USB device connects to and communicates with the USB host via the USB interconnect. To minimize power consumption, the USB host can enter a low power mode (in other words, a minimum power state) during idle activity or non-use, for example, after a time period of no communication with a connected USB device or after a USB device has been detached from the USB host. During standby mode, the USB host is configured to detect a USB plug-in event—when a USB device is attached (connected) to a USB interface associated with the USB host—and awaken (in various implementations, power up to an active mode) upon detecting the USB plug-in event. Current USB systems strive to minimize power consumption for detecting USB plug-in events, particularly as standby power consumption guidelines continue to decrease in efforts to achieve energy efficient systems and devices. Although existing USB systems for detecting USB plug-in events and associated methods have been generally adequate for their intended purposes, they have not been entirely satisfactory in all respects.

### BRIEF DESCRIPTION OF DRAWINGS

The present disclosure is best understood from the following detailed description when read with the accompanying figures. It is emphasized that, in accordance with the standard practice in the industry, various features are not drawn to scale and are used for illustration purposes only. In fact, the dimension of the various features may be arbitrarily increased or reduced for clarity of discussion.

FIG. 1 is a simplified block diagram of an exemplary USB system according to various aspects of the present disclosure.

FIG. 2 is a simplified block diagram of another exemplary USB system according to various aspects of the present disclosure.

FIG. 3 is a simplified block diagram of yet another exemplary USB system according to various aspects of the present disclosure.

FIG. 4 is a flowchart of an exemplary method for detecting a USB plug-in event that can be implemented by a USB system, such as the USB systems described and illustrated in FIG. 1, FIG. 2, and FIG. 3, according to various aspects of the present disclosure.

### OVERVIEW OF EXAMPLE EMBODIMENTS

The present disclosure provides generally for universal serial bus (USB) plug-in event detection systems and associated USB plug-in event detection methods. An exemplary USB system can include a USB interface and a USB capacitive-sensing detection module coupled with a data line of the USB interface. The USB capacitance-sensing detection module monitors a change in capacitance on the data line to detect a USB plug-in event. The USB capacitance-sensing detection module can detect the USB plug-in event when the USB interface is in a powered-down state. The USB system can further include a USB host. The USB host can be in a standby or hibernation mode (minimum power state) when the USB capacitive-sensing detection module detects the USB plug-in event, and the USB system can be configured to wake-up the USB host from the standby or hibernation mode upon detecting the USB plug-in event.

The USB host includes a USB host processor communicatively coupled with the USB capacitance-sensing detection module, and the USB system is configured such that the USB host processor is notified when the USB capacitance-sensing detection module detects the USB plug-in event. The USB interface can include a USB host controller that is coupled to USB host processor, where the USB host processor can be configured to power up the USB host controller upon being notified of the USB plug-in event. In various implementations, the USB capacitive-sensing detection module is on a same integrated circuit chip as the USB host controller. In various implementations, the USB capacitive-sensing detection module includes a capacitance-to-digital converter and/or a scaling network.

An exemplary method includes monitoring a capacitance on a data line of a USB interface and detecting a capacitance change on the data line that indicates a USB plug-in event. The detecting can include determining whether the capacitance change meets a threshold. In various implementations, the USB plug-in event detection is achieved at power levels less than traditional USB plug-in event detection methods, in some implementations, a power level that is as much as magnitudes lower than the traditional USB plug-in event detection methods. The method can further include initiating a USB host wakeup upon detecting the capacitance change. In various implementations, the method further includes generating a wake-up signal upon detecting the capacitance change. A USB host processor may receive the wake-up signal and initiate a USB host wakeup process upon receiving the wake-up signal. In various implementations, the method further includes powering the USB interface, such as a USB host controller and/or USB port, upon detecting the capacitance change.

An exemplary apparatus includes a USB host, a USB device, and a USB interconnect, where the USB interconnect can facilitate connection and communication between the USB host and the USB device when the USB device is attached to the USB host. The USB host includes a powered-down USB port, and a USB capacitive-sensing detection module coupled with a data line of the powered-down USB port. The USB capacitance-sensing detection module is configured to detect when the USB device is attached to the powered-down USB port. The USB host is configured to power up the USB port when the USB capacitance-sensing detection module detects that the USB device is attached to the USB port. In various implementations, the data line is a D+ signal line, a D− line, or both the D+ signal line and the D− signal line of a USB interconnect. The USB capacitive-sensing detection module can include a capacitance-to-digital converter that detects a capacitance change when the USB device is attached to the powered-down USB port.

### Detailed Description of Example Embodiments

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed.

Lowering power consumption in AC (alternating current) and DC (direct current) powered applications presents constant design challenges. For example, various programs, such as the ENERGY STAR® program, set standards for certifying AC-powered and DC-powered devices (such as DVD players, TVs, computers, printers, and so on) as energy efficient. These standards typically specify power consumption guidelines for at least two states of operation: an active mode and a standby mode. In the active mode, the device is in fully powered operation. In the standby mode, the device is partially powered down to reduce overall power consumption. For example, a portion of the device is powered down or powered at its lowest power state, while a portion of the device remains active to provide some device functionality. In various implementations, a portion of the device remains active for user intervention detection, where the device detects when a user interfaces with the device, signaling that the device needs to exit standby mode and power up to active mode. Standby mode refers to any low or ultralow power mode including sleep mode, hibernation mode, or any other mode where the device enters a lower power state, when compared to its active mode.

Current ENERGY STAR® guidelines specify that any device operating in standby mode must consume less than 1 W of power. It is expected that these guidelines will continue to become stricter, decreasing standby power consumption goals to less than about 0.5 W of power. Many devices, such as printers, spend a significant amount of time in standby mode, and such devices often remain in standby mode until detecting a wake-up event, at which time the devices will power up to active mode. In various implementations, a wake-up event occurs when a user engages a user interface associated with the device, such as engaging a power button or other button of the device or engaging a peripheral device coupled to the device. In various implementations, a universal serial bus (USB) system facilitates a connection and communication between devices, where a wake-up event occurs when a device detects a USB plug-in event (that another device has been attached to a USB interface of the device). Typically, in standby mode, AC-to-DC power conversion accounts for a largest portion of standby power draw (for example, 0.3 W to 0.5 W in many applications), leaving little overhead power available for detecting network activity or user intervention detection, such as detecting a wake-up event or USB plug-in event. Efforts have thus been made to provide systems and methods that can consume minimal power to detect wake-up events.

The present disclosure explores various systems and methods that minimize power needed to detect wake-up events, and in particular, provides various USB systems and methods that minimize power requirements for detecting USB plug-in events. For example, in various implementations, the USB systems described herein implement a capacitive-sensing detection module for detecting USB plug-in events. The capacitive-sensing detection module consumes significantly less power than traditional USB plug-in detection modules. While the capacitive-sensing detection module detects USB plug-in events, a USB system can power down a USB interface, such as a USB hub. In various implementations, the USB systems described herein can remove a significant power consumer, for example, by powering off the USB hub and any associated power converters that operate during standby, from traditional USB systems, allowing AC-powered appliances with USB interfaces to achieve standby power consumption of less than about 0.5 W. The USB systems and methods described herein can thus significantly reduce power needed for detecting USB-plug in events, in some implementations, achieving as much as a 1000:1 reduction over traditional USB systems and methods (which can consume as much as 50% of their standby power to reliably detect USB plug-in events).

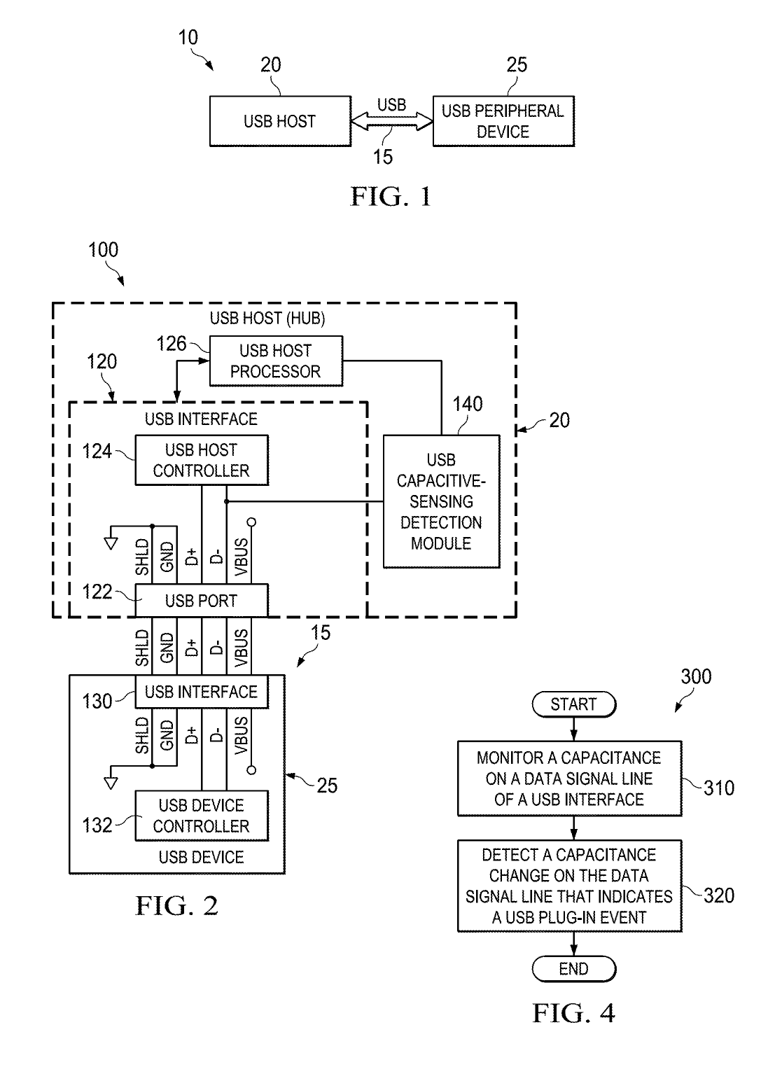

FIG. 1 is a simplified block diagram of an exemplary USB system 10 according to various aspects of the present disclosure. USB system 10 (including a USB interconnect 15, a USB device 20, and a USB device 25) is configured and operates according to protocols and specifications comporting with USB standards up through USB 3.0. It is understood that the USB system 10 can further be configured and operate according to protocols and specifications comporting with other USB standards. FIG. 1 has been simplified for the sake of clarity to better understand the inventive concepts of the present disclosure. Additional features can be added in USB system 10, and some of the features described can be replaced or eliminated in other embodiments of USB system 10.

As noted, the USB system 10 includes USB interconnect 15, USB device 20 (for example, a USB host or hub), and USB device 25 (for example, a USB peripheral device). USB system 10 supports communication services (such as data exchange) between USB host 20 and USB device 25 via USB interconnect 15. In the depicted embodiment, USB interconnect 15 (wired and/or wireless) facilitates connection and communication between USB host 20 and USB device 25, such that USB host 20 is communicatively coupled to USB device 25. It is noted that the communicative coupling includes any electrical coupling means, mechanical coupling means, other coupling means, or a combination thereof that facilitates the connection and communication between USB host 20 and USB device 25. In various implementations, USB device 20 and/or USB device 25 is any device that implements USB functionality, such as a computer, a personal digital assistant (PDA), a phone (such as a mobile phone), a hub, a user interface device (such as a pen, a keyboard, a mouse, a trackball, a joystick, a microphone, a display, a monitor, a speaker, or other user interface device), an imaging device (such as a printer, a scanner, a digital camera, or other imaging device), a communication device, a data storage device (such as a flash memory, a hard drive, an optical drive, a thumb drive, or other data storage device), an expansion card, a communication device, a video and/or audio device (for example, a MP3 player), a network-based device, a data processing device, other device that implements USB functionality, or a combination thereof.

FIG. 2 is a simplified block diagram of another exemplary USB system 100 according to various aspects of the present disclosure. USB system 100 is configured and operates according to protocols and specifications comporting with USB standards up through USB 3.0. It is understood that the USB system 100 can further be configured and operate according to protocols and specifications comporting with other USB standards. In the depicted embodiment, and in furtherance of discussion herein, references to “USB Standards” refer to Universal Serial Bus Revision 2.0 Specification and its corresponding supplementations and amendments. The embodiment of FIG. 2 is similar in many respects to the embodiment of FIG. 1. Accordingly, similar features in FIG. 1 and FIG. 2 are identified by the same reference numerals for clarity and simplicity. Further, FIG. 2 has been simplified for the sake of clarity to better understand the inventive concepts of the present disclosure. Additional features can be added in the USB system 100, and some of the features described below can be replaced or eliminated in other embodiments of the USB system 100.

Similar to USB system 10, USB system 100 supports communication services (such as data exchange) between USB host 20 and USB device 25 via USB interconnect 15. In particular, USB interconnect 15 facilitates connection and communication between USB host 20 and USB device 25. USB interconnect 15 includes various USB signal lines for supporting data traffic between USB host 20 and USB device 25. In the depicted embodiment, USB interconnect 15 includes five USB signal lines: a power supply line VBUS, a data line D−, a data line D+, a ground line GND, and an optional identification line SHLD. When USB device 25 is attached (connected) to USB host 20, USB host 20 can provide power to USB device 25 via the VBUS signal line, and USB host 20 can provide a reference return for USB device 25 via the GND signal line. In various implementations, a switched voltage source, such as 5 V, supplies power to USB device 25 via the VBUS signal line. The switched voltage can be connected and disconnected from USB device 25 by USB host 20. In various implementations, the voltage supplied to USB device 25 can vary by ±10%. Further, the D− signal line and the D+ signal line are differential USB data signals that provide data paths for USB information flow between USB host 20 and USB device 25, such that when USB device 25 is attached to USB host 20, USB host 20 and USB device 25 can engage in data communications via the D− and D+ signal lines. In various implementations, the D− and D+ signal lines have various pull-up and pull-down states for speed negotiation over the USB interconnect 15.

USB host 20 is configured to control access to USB interconnect 15 and communications between USB host 20 and USB device 25 via the USB interconnect 15. For example, USB host 20 manages control and data flow between USB host 20 and USB device 25, detects attachment and removal of USB device 25 from the USB host 20, collects status and activity statistics, provides power to attached USB devices (such as USB device 25), other functions, or a combination thereof. USB host (hub) 20 can include a USB interface 120 (in the depicted embodiment, having a USB port 122 and a USB host controller 124 coupled to the USB port 122) and a USB host processor 126 coupled to the USB interface 120, and USB device 25 can include a USB interface 130 and a USB device controller 132 coupled to the USB interface 130. USB port 122 represents a point where USB device 25 attaches (connects) to USB host 20. In various implementations, USB device 25 may be attached to USB host 20 directly (for example, plugged into the USB port 122) or indirectly (for example, via a USB cable plugged into the USB port 122). In various implementations, the switched voltage source, such as 5 V, supplies power to USB port 122, and can be connected and disconnected from USB port 122 by USB host 20. USB host controller 124 can manage the data flow between USB host 20 and USB device 25.

To minimize power consumption and meet various power consumption standards (such as the ENERGY STAR® guidelines noted above, which currently specify 1 W as the standby power consumption goal), USB host 20 can enter a minimum power state (such as a standby or hibernation mode) during idle activity or non-use. When in standby mode, USB host 20 is configured to awaken (in various implementations, power up to an active mode) upon a USB plug-in event—when USB device 25 is attached to USB host 20. For example, when USB device 25 is plugged (or inserted) into the USB interface 120, such as USB port 122, USB host 20 awakens from standby mode to manage and control data communications between USB device 25 and USB host 20. In various implementations, USB host 20 is a printer, and USB device 25 is a memory storage device. The printer can spend significant time in standby mode, where USB system 100 is configured so that the printer wakes up and powers up quickly upon detecting that the memory storage device has been attached to the printer (in other words, upon detecting a USB plug-in event).

Typically, USB host 20 can detect USB plug-in events using a bus enumeration process, which is described in the USB Standards. For example, in various implementations, USB host controller 124 can monitor USB port 122 for a USB enumeration event on data signal lines of USB interface 120 (here, D+/D− signal lines) and notify (flag) USB host processor 126 to awaken from standby mode upon detecting the USB enumeration event. Such implementations often require powering the USB interface 120 during standby mode, for example, by continuously powering USB host controller 124 and/or USB port 122. For example, since USB Standards specify that USB port 122 needs a 5 V power supply to provide power to a USB device attached thereto, USB port 122 is powered by 5 V during standby mode to facilitate USB enumeration (and thus, detection of USB plug-in events). In various implementations, USB host 20 can include a 5 V power source that powers USB host controller 124 and USB port 122 during standby mode. In various implementations, to reduce standby power consumption, USB host 20 can include a power source lower than 5 V (for example, a 3.3 V or lower power source) that powers USB host controller 124, where USB host 20 is configured to generate a continuous 5 V power supply for USB port 122 from the lower power source. USB host 20 may include additional components for generating the continuous 5 V power supply for the USB port 122, such as a boost converter to generate 5 V from the power source for the USB host controller 124. Generating 5 V from the lower power supply source can present various disadvantages, including increasing costs and components for the USB system 100. Further, such power schemes can consume more standby power than desirable. For example, in a specific implementation, during standby mode, a 3.3 V power supply source can power USB host controller 124, and USB host 20 can be configured to generate 5 V from the 3.3 V power supply source to power USB port 122. In such implementation, USB host controller 124 may consume about 180 mW to 200 mW of power (where power consumption in active mode may be about 3% to 5% higher, on average), and conversion efficiency for powering USB port 122 may be about 70%, thereby leading to a standby power consumption of about 250 mW to detect USB plug-in events.

Since various power consumption guidelines are expected to lower standby power consumption goals, such as to a standby power consumption goal of less than about 0.5 W, typical standby power configurations for detecting USB plug-in events can consume a significant portion of a USB system's standby power budgets (as much as 50% in the power scheme described above, which uses about 250 mW of standby power to detect USB plug-in events). These standby power requirements may become unsustainable as efforts continue to minimize power consumption. Accordingly, as described in detail below, USB system 100 is configured to detect USB plug-in events while minimizing power consumption (when USB host 20 is in both active and standby mode), minimizing system components for such detection, minimizing costs for such detection, or a combination thereof. In various implementations, USB system 100 can detect USB plug-in events without powering USB interface 120, specifically without powering USB port 122, thereby eliminating the 5 V standby power supply source and/or any power consumption associated with powering USB host controller 124 and converting such power to the 5 V typically necessary for detecting USB plug-in events. As described below, in various embodiments, USB system 100 can achieve such improvements by implementing a USB capacitive-sensing detection module for detecting USB plug-in events. Embodiments described herein may have various advantages (including those described herein), and no particular advantage is necessarily required of any embodiment.

In FIG. 2, USB system 100 includes a USB capacitive-sensing detection module 140 for detecting USB plug-in events. USB capacitive-sensing detection module 140 can detect USB plug-in events while USB interface 120 is in a powered-down state. In various implementations, as described further below, USB port 122, USB host controller 124, or both are in a powered-down state when the USB capacitive-sensing detection module 140 detects USB plug-in events. It is understood that USB capacitive-sensing detection module 140 can also detect USB plug-in events when USB interface 120 (including USB port 122 and/or USB host controller 124) is in a powered-up state. The USB capacitive-sensing detection module 140 disclosed herein transparently interfaces with USB system 100 without affecting USB functionality, such as USB interface 120 functionality.

USB capacitive-sensing detection module 140 is coupled to a USB signal line of USB interface 120 (here, the VBUS, GND, D+, or D− signal line) and monitors capacitance changes on the USB signal line to detect USB plug-in events. For example, in various implementations such as the depicted embodiment, USB capacitive-sensing detection module 140 is coupled with a USB data signal line (here, the D+ signal line and/or the D− signal line) of USB interface 120 and monitors capacitance changes on the USB data signal line to detect USB plug-in events. The USB data signal lines are, by nature, “low-capacitance” paths. For example, USB system 100 can operate in various modes, including low-speed, full-speed, and high-speed modes, where the high-speed mode facilitates data transfer rates between USB host 20 and USB device 25 on the USB data paths (here, the D+/D− signal lines) of USB interconnect 15 as high as 480 Mb/s. USB Standards also provide well-defined impedance characteristics for the data signal lines, nominally a differential characteristic impedance of 90Ω±15% and loosely controlled single-ended characteristic impedance (for example, in various implementations, single-ended characteristic impedance can range from about 42Ω to about 78Ω). Further, an inherent (baseline) capacitance on the host-side USB data signal lines can range from single to double digit picofarads (pF), where the capacitance variation arises from the USB host controller 124 itself, EMI/RFI (electromagnetic interference/radio frequency interference) protection components, ESD (electrostatic discharge) protection components, other components, any parasitic capacitance to ground, or a combination thereof. For high-speed mode, USB Standards indicate that a maximum capacitance to ground on each USB data signal line is less than or equal to about 10 pF. This maximum capacitance can includes capacitance from the USB host controller 124 (which is specified as less than about 5 pF) and any capacitance from external components (which is also specified as less than about 5 pF) (including the EMI/RFI protection components, the ESD protection components, connector components, other external components, or combinations thereof).

The low capacitance and well-regulated nature of the USB data signal lines can facilitate reliable detection of USB plug-in events. For example, the present disclosure recognizes that a USB plug-in event causes an abrupt change in the inherent (baseline) capacitance on the host-side USB data signal lines (here, the D+/D− signal lines), even when the host-side's USB interface (such as the host-side's USB port) is in a powered-down state. In various implementations, it has been observed that a USB plug-in event at least doubles the effective capacitance on the host-side USB data signal lines. Such capacitance change can thus be monitored to reliably detect USB plug-in events, even when the USB interface 120 is in a powered-down state. Accordingly, in FIG. 2, USB capacitive-sensing detection module 140 is coupled with a USB data signal line of USB interface 120 to monitor these capacitance changes, as described more fully below.

USB capacitance-sensing detection module 140 can reliably detect USB plug-in events by monitoring a change in capacitance on a single USB data signal line or more than one USB data signal line. In the depicted embodiment, USB capacitive-sensing detection module 140 is coupled with the D− signal line of USB interface 120, between USB port 122 and USB host controller 124. Alternatively, USB capacitive-sensing detection module 140 is coupled with the D+ signal line of USB interface 120, between USB port 122 and USB host controller 124. In various implementations, USB capacitive-sensing detection module 140 is coupled with the data signal line at a point closest to USB port 122. For example, in some embodiments, where USB system 100 includes various other components (such as various protection components and/or filter components) connected in series between USB host controller 124 and USB port 122, USB capacitive-sensing detection module 140 is coupled with the data signal line of the USB interface 120 at a location that results in no intervening components between USB port 122 and USB capacitive-sensing detection module 140. In various implementations, USB capacitance-sensing detection module 140 is coupled with more than one USB data signal line, such as both the D− signal line and D+ signal line, to monitor USB plug-in events.

USB capacitive-sensing detection module 140 notifies (flags) USB host 20 upon detecting a capacitance change on the USB data signal line. In various implementations, USB capacitive-sensing detection module 140 monitors a capacitance on the USB data signal line of USB interface 120, detects when a capacitance change on the USB data signal line indicates a USB plug-in event, and notifies USB host 20 upon detecting the capacitance change. In various implementations, USB capacitive-sensing detection module 140 is configured to determine whether a detected capacitance change meets a threshold capacitance change, where the threshold defines a range of capacitance change that indicates that USB device 25 is attached to USB interface 120. It is noted that a sensitivity of USB capacitive-sensing detection module 140 can also facilitate detecting when a USB cable is attached to USB interface 120, without USB device 25 being attached to the USB cable. Thus, for purposes of the discussion herein, USB plug-in events can also include situations where the USB cable alone is attached to USB interface 120.

In various implementations, where USB host 20 has entered standby mode, USB capacitive-sensing detection module 140 monitors the USB data signal line for a capacitance change that indicates a USB plug-in event and notifies USB host 20 to awaken from standby mode upon detecting the USB plug-in event. For example, USB capacitive-sensing detection module 140 generates a wake-up signal upon detecting the capacitance change on the USB data signal line. In the depicted embodiment, USB capacitive-sensing detection module 140 is communicatively coupled to USB host processor 126, such that USB host processor 126 receives the wake-up signal. USB host processor 126 can then wake up from standby mode and power up USB interface 120, such as USB host controller 124 and/or USB port 122.

Alternatively, in various implementations, USB capacitive-sensing detection module 140 can be coupled with the VBUS signal line of USB interface 120 and monitor capacitance changes on the VBUS signal line to detect USB plug-in events. Since the capacitance can vary significantly on the VBUS line, such detection may present challenges to achieve a robust USB plug-in event detection strategy, which may lead to increased power consumption and circuit complexity for USB system 100. For example, since USB Standards specify that a load current on the VBUS signal line can vary from 0 to a maximum of about 500 mA, and capacitance and resistance to ground can be highly variable (effectively “unregulated” except for the specified maximum load current), VBUS signal line is essentially a low impedance power supply signal that can exhibit a wide range of capacitance (for example, in various implementations, between about 1 μF and about 100 μF). VBUS signal line can also exhibit non-linear impedance resulting from direct connections to the USB host controller 124 and other power supply outputs that may be in an unpowered state. These large and varied capacitance changes can present difficulties in identifying capacitance changes associated with USB plug-in events, in some implementations, resulting in measurements that require significant power and analysis for reliable USB plug-in event detection (often because the loads on the VBUS signal line may be complex, relatively uncontrolled, non-linear and/or low impedance). In various implementations, to facilitate reliable USB plug-in even detection on the VBUS signal line, USB system 100 can be configured with a scaling circuit to offset bulk capacitance on the VBUS signal line or with a signal drive that detects higher capacitance values, consistent with those observed on the VBUS signal line.

Alternatively, in yet other various implementations, USB capacitive-sensing detection module 140 can be coupled with the GND signal line of USB interface 120 and monitor capacitance changes on the GND signal line to detect USB plug-in events. However, in many configurations, a ground pin of USB capacitive-sensing detection module 140 may be shared with a ground pin of the GND signal line, such that there is effectively no capacitance between them, and thus no detectable capacitance changes. Accordingly, configurations that monitor capacitance changes on the GND signal line may not provide reliable USB plug-in event detection (particularly not as reliable as configurations that monitor capacitance changes on the data lines, as in the depicted embodiment, or the VBUS line).

Returning to the depicted embodiment, USB host 20 includes USB capacitive-sensing detection module 140. In various implementations, USB capacitive-sensing detection module 140 is a stand-alone integrated circuit chip (which can be referred to as a capacitance detection chip), and USB interface 120 is a stand-alone integrated circuit chip (which can be referred to as a USB hub chip), such that the capacitance detection chip is external to the USB hub chip. In various implementations, USB capacitive-sensing detection module 140 is a stand-alone integrated circuit chip, and USB host controller 124 is a stand-alone integrated circuit chip. Alternatively, USB interface 120, USB host (hub) controller 124, or USB port 122 can include the USB capacitive-sensing detection module 140. For example, in some implementations, USB system 100 is configured to integrate USB plug-in detection and USB interface functionality (such as USB host or hub controller functionality) on a same integrated circuit chip, such that in some embodiments, USB capacitive-sensing detection module 140 and USB host controller 124 are on a same integrated circuit chip. In some embodiments, USB capacitive-sensing detection module 140 is on a same integrated circuit chip as USB interface 120 and/or USB port 122. In various implementations, the USB system 100 can also be configured to have any of its components on stand-alone integrated circuit chips or one or more components on a same integrated circuit chip.

Further, in the depicted embodiment, USB capacitive-sensing detection module 140 monitors a capacitance on a USB data signal line associated with a single USB port, USB port 122. Alternatively, in various implementations, USB capacitive-sensing detection module 140 monitors capacitances of USB data signal lines associated with different USB ports. For example, in some embodiments, USB capacitive-sensing detection module 140 is coupled with more than one USB data signal line, where each data signal line is coupled with an associated USB port. The various USB ports can be included in a single USB interface, such as USB interface 120, or different USB interfaces. The various USB ports can each interface with USB host controller 124 or different USB host controllers. Various other configurations are contemplated by the present disclosure.

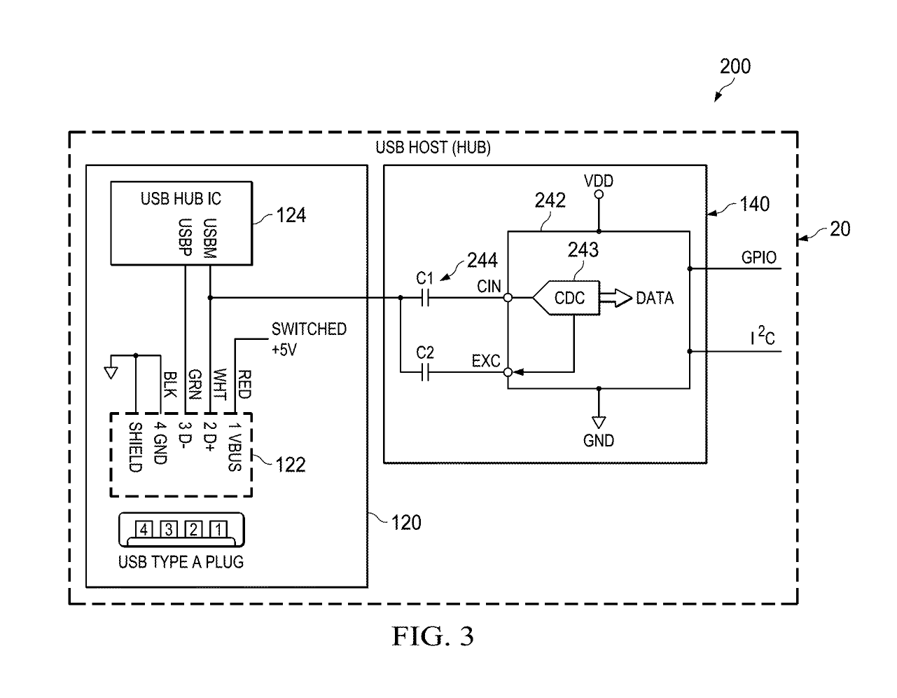

FIG. 3 is a simplified block diagram of another exemplary USB system 200 according to various aspects of the present disclosure. USB system 200 is configured and operates according to protocols and specifications comporting with USB standards up through USB 3.0. It is understood that the USB system 200 can further be configured to operate according to protocols and specifications comporting with other USB standards. The embodiment of FIG. 3 is similar in many respects to the embodiments of FIG. 1 and FIG. 2. Accordingly, similar features in FIG. 1, FIG. 2, and FIG. 3 are identified by the same reference numerals for clarity and simplicity. FIG. 3 has been simplified for the sake of clarity to better understand the inventive concepts of the present disclosure. Additional features can be added in the USB system 200, and some of the features described below can be replaced or eliminated in other embodiments of the USB system 200.

Similar to USB system 10 and USB system 100, USB system 200 includes USB host 20 having the USB interface 120. The USB interface 120 includes the USB port 122 and the USB host controller 124. Further, similar to USB system 100, USB system 200 includes USB capacitance-sensing detection module 140 coupled to a USB data signal line (in the depicted embodiment, the D− signal line) of USB interface 120, and USB capacitance-sensing detection module 140 monitors capacitance on the USB data signal line to detect USB plug-in events.

In FIG. 3, USB capacitive-sensing detection module 140 includes a capacitance-to-digital converter (CDC) 242. CDC 242 detects capacitance changes on the data signal line and determines whether the detected capacitance changes meet a threshold that indicates a USB plug-in event (also referred to as a defined or trigger threshold, rate, or range). The CDC 242 can flag a capacitance change as a USB plug-in event when the capacitance change meets the threshold. In various implementations, CDC 242 flags the event (a capacitance change meeting the threshold) as a digital input/output (I/O) transition. CDC 242 includes internal circuit logic that can automatically adapt the trigger threshold with environmental variations that may cause capacitance changes to falsely trigger a USB plug-in event. CDC 242 also includes internal circuit logic that can facilitate automatic calibration for manufacturing variances of the USB system 300, such that costly per-product calibrations for USB systems that implement USB capacitive-sensing detection module 140 can be minimized or completely eliminated. In various implementations, CDC 242 is from Analog Devices, Inc.'s (ADI's) Model No. AD715x family of capacitance-to-digital converters or ADI's Model No. AD714x family of capacitance-to-digital converters.

The USB system 300 can be configured so that a single channel CDC can monitor a single USB port for USB plug-in events, a dual channel CDC can monitor a single USB port or two USB ports for USB plug-in events, or a multiple channel CDC can monitor a single USB port or more than one USB port for USB plug-in events. In the depicted embodiment, CDC 242 is depicted as a single channel CDC having a CDC 243 (for example, a Σ-Δ CDC), a capacitive input channel (CIN), a CDC excitation output channel (EXC), a logic output channel associated with the CDC input channel (here, depicted as GPIO—general purpose input/output channel), a ground pin (GND), a power supply voltage (VDD), and an I²C channel (such that the CDC 242 includes an I²C-compatible serial interface). CDC 242 can measure a capacitance on the data signal line between the CIN and EXC channels, where the CDC 243 can be configured to convert the capacitance measurement into a digital signal (represented as DATA in FIG. 3). When CDC 242 detects a capacitance change that indicates a USB plug-in event (for example, USB device 25 is plugged into USB port 122), the GPIO channel enters its active state. In various implementations, the CDC's output channel (here, the GPIO channel and/or the I²C channel) interfaces with USB host processor 126 so that the USB host processor 126 is notified upon detection of the USB plug-in event. For example, in various implementations, the GPIO channel can be interfaced with an interrupt pin of the USB host processor 126. USB host processor 126 can initiate a wake-up process upon notification of the USB plug-in event, such as that described above.

USB capacitive-sensing detection module 140 further includes a scaling network 244 that can optimize the ability of CDC 242 to detect capacitance changes on the USB data signal lines. The scaling network 244 is configured to reduce any capacitance change observed by the CDC 242 (here, on the CIN and EXC input channels), while having little to no impact on signaling of the USB data signal lines. For example, in various implementations, a capacitance change on the data signal line that indicates a USB plug-in event may be larger than an input range of the CDC 242 (for example, in specific implementations, a capacitance on the D− signal line may jump several picofarads (such as 10s of pFs) while the CDC 242 can detect capacitances from about 0 pF to about 13 pF); and the scaling network 244 reduces the effective capacitance seen by the input channels of the CDC 242, such that the CDC 242 observes capacitance changes within its capacitance sensor range. In the depicted embodiment, scaling network 244 is a capacitive divider that includes a capacitor C1 and a capacitor C2. The capacitive divider can divide down effective capacitances seen by the CDC 242 so that the CDC 242 can respond to capacitance changes that indicate USB plug-in events. In various implementations, capacitor C1 and capacitor C2 have a capacitance value that has no effective impact on signaling of the USB data signal lines, such as a capacitance value of about 1 pF to about 3 pF. This ensures that the maximum load capacitance on the USB data signal lines satisfies USB Standards, which is currently specified as less than about 10 pF. The scaling network 244 can also isolate and protect the CDC 242, for example, by providing DC decoupling of any DC bias signals on the USB data signal lines.

Implementing USB capacitive-sensing detection module 140 with CDC 242 can provide a low power, low cost solution for reliably detecting USB plug-in events. For example, in various implementations, CDC 242 specifications provide for 70 μA current consumption, such that when CDC 242 is powered with a 3.3 V power supply (via VDD), USB capacitive-sensing detection module 140 consumes about 230 μW of power. USB capacitive-sensing detection module 140 can thus detect USB plug-in events using about 1000 times less power than typical USB system configurations, such as those described herein. As noted above, such detection can be performed while the USB host 20 is in standby mode, thereby significantly reducing the standby power requirements for USB plug-in event detection. In various implementations, USB interface 120 and USB capacitive-sensing detection module 140 can be configured to consume less than about 125 μW of power while USB host 20 is in a powered down state. For example, in some implementations, USB system 300 can be configured to power CDC 242 with a 1.8 V power supply.

FIG. 4 is a flowchart of an exemplary method 300 for detecting a USB plug-in event that can be implemented by a USB system, such as the USB systems described and illustrated in FIG. 1, FIG. 2, and FIG. 3, according to various aspects of the present disclosure. At block 310, a capacitance on a data signal line of a USB interface is monitored. In various implementations, the USB interface is in a powered-down state. At block 320, a capacitance change is detected on the data signal line. In various implementations, the detected capacitance change indicates a USB plug-in event, for example, that a USB device is attached to the USB interface. In various implementations, where the USB interface in the powered-down state, the method can further include powering up the USB interface upon detecting the capacitance change. In various implementations, the method can further include initiating a wake-up process upon detecting the capacitance change. FIG. 4 has been simplified for the sake of clarity to better understand the inventive concepts of the present disclosure. Additional steps can be added in the method 300, and some of the steps described herein can be replaced or eliminated in other embodiments of the method 300.

In various implementations, the various functions (such as the monitoring, detecting, initiating, generating, waking, signaling, and other functions) outlined herein may be implemented by logic encoded in one or more non-transitory and/or tangible media (for example, e.g., embedded logic provided in an application specific integrated circuit (ASIC), a digital signal processor (DSP) instructions, software (potentially inclusive of object code and source code) to be executed by a processor, or other similar machine, etc.). In some of these instances, a memory element can store data used for the operations described herein. This includes the memory element being able to store logic (for example, software, code, processor instructions) that is executed by a processor to carry out the activities described herein. The processor can execute any type of instructions associated with the data to achieve the operations detailed herein. In various implementations, the processor can transform an element or an article (such as data) from one state or thing to another state or thing. In another example, the activities outlined herein may be implemented with fixed logic or programmable logic (such as software/computer instructions executed by the processor) and the elements identified herein can be some type of a programmable processor (such as a DSP), programmable digital logic (e.g., a FPGA, an erasable programmable read only memory (EPROM), an electrically erasable programmable ROM (EEPROM)), or an ASIC that includes digital logic, software, code, electronic instructions, or any suitable combination thereof.

Some embodiments may be implemented, for example, using a non-transitory computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disc Read Only Memory (CD-ROM), Compact Disc Recordable (CD-R), Compact Disc Rewriteable (CD-RW), optical disk, magnetic media, magneto-optical media, removable memory cards or disks, various types of Digital Versatile Disc (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The various USB systems and/or components described herein may be implemented in hardware, firmware, software, or a combination thereof. Examples of hardware can include processors, microprocessors, circuits, circuit elements (for example, transistors, resistors, capacitors, inductors, and so forth), integrated circuits, application specific integrated circuits (“ASIC”), programmable logic devices (“PLD”), digital signal processors (“DSP”), field programmable gate arrays (“FPGA”), logic gates, registers, semiconductor devices, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (“API”), instruction sets, computing code, computer code, code segments, computer code segments, words, values, symbols, or any combination thereof.

In various implementations, the various USB system components (such as USB interface 120, USB port 122, USB host processor 126, USB interface 130, USB device controller 132, and/or USB capacitive-sensing detection module 140) of the FIGURES can be implemented on a board of an associated electronic device. The board can be a general circuit board that can hold various components of an internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), memory elements, etc. can be suitably coupled to the board based on particular configuration needs, processing demands, computer designs, other considerations, or a combination thereof. Other components, such as external storage, sensors, controllers for audio/video display, and peripheral devices may be attached to the board as plug-in cards, via cables, or integrated into the board itself.

In various implementations, the various USB system components (such as USB interface 120, USB port 122, USB host processor 126, USB interface 130, USB device controller 132, and/or USB capacitive-sensing detection module 140) of the FIGURES can be implemented as stand-alone modules (for example, a device with associated components and circuitry configured to perform a specific application or function) or implemented as plug-in modules into application specific hardware of electronic devices. Note that particular embodiments of the present disclosure may be readily included in a system-on-chip (SOC) package, either in part, or in whole. An SOC represents an integrated circuit that integrates components of a computer or other electronic system into a single chip. It may contain digital, analog, mixed-signal, and often radio frequency functions: all of which may be provided on a single chip substrate. Other embodiments may include a multi-chip-module (MCM), with a plurality of separate ICs located within a single electronic package and configured to interact closely with each other through the electronic package. In various other embodiments, the various functions described herein may be implemented in one or more semiconductor cores (such as silicon cores) in application specific integrated circuits (ASICs), field programmable gate arrays (FPGAs), other semiconductor chips, or combinations thereof.

The specifications, dimensions, and relationships outlined herein have only been offered for purposes of example and teaching only. Each of these may be varied considerably without departing from the spirit of the present disclosure, or the scope of the appended claims. The specifications apply only to non-limiting examples and, accordingly, they should be construed as such. In the foregoing description, example embodiments have been described with reference to particular processor and/or component arrangements. Various modifications and changes may be made to such embodiments without departing from the scope of the appended claims. The description and drawings are, accordingly, to be regarded in an illustrative rather than a restrictive sense.

Further, the operations and steps described with reference to the preceding FIGURES illustrate only some of the possible scenarios that may be executed by, or within, the various apparatuses, processors, devices, and/or systems, described herein. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion. Substantial flexibility is provided by the system in that any suitable arrangements, chronologies, configurations, and timing mechanisms may be provided without departing from the teachings of the discussed concepts.

Note that the activities discussed above with reference to the FIGURES are applicable to any integrated circuits that involve signal processing, particularly those that can execute specialized software programs, or algorithms, some of which may be associated with processing digitized real-time data. Certain embodiments can relate to multi-DSP signal processing, floating point processing, signal/control processing, fixed-function processing, microcontroller applications, etc.

In certain contexts, the features discussed herein can be applicable to medical systems, scientific instrumentation, wireless and wired communications, radar, industrial process control, audio and video equipment, current sensing, instrumentation (which can be highly precise), and other digital-processing-based systems. Moreover, certain embodiments discussed above can be provisioned in digital signal processing technologies for medical imaging, patient monitoring, medical instrumentation, and home healthcare. This could include pulmonary monitors, accelerometers, heart rate monitors, pacemakers, etc. Other applications can involve automotive technologies for safety systems (e.g., stability control systems, driver assistance systems, braking systems, infotainment and interior applications of any kind). Furthermore, powertrain systems (for example, in hybrid and electric vehicles) can use high-precision data conversion products in battery monitoring, control systems, reporting controls, maintenance activities, etc. In yet other example scenarios, the teachings of the present disclosure can be applicable in the industrial markets that include process control systems that help drive productivity, energy efficiency, and reliability. In consumer applications, the teachings of the signal processing circuits discussed above can be used for image processing, auto focus, and image stabilization (e.g., for digital still cameras, camcorders, etc.). Other consumer applications can include audio and video processors for home theater systems, DVD recorders, and high-definition televisions. Yet other consumer applications can involve advanced touch screen controllers (e.g., for any type of portable media device). Hence, such technologies could readily part of smartphones, tablets, security systems, PCs, gaming technologies, virtual reality, simulation training, etc.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this Specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Further, note that references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments. It is further noted that “coupled to” and “coupled with” are used interchangeably herein, and that references to a feature “coupled to” or “coupled with” another feature include any communicative coupling means, electrical coupling means, mechanical coupling means, other coupling means, or a combination thereof that facilitates the feature functionalities and operations, such as the detection mechanisms, described herein.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “steps for” are specifically used in the particular claims; and (b) does not intend, by any statement in the specification, to limit this disclosure in any way that is not otherwise reflected in the appended claims.

Example Embodiment Implementations

One particular example implementation may include an apparatus having means for monitoring a capacitance on a data line of a USB interface and detecting a capacitance change on the data line that indicates a USB plug-in event. Various implementations can further include means for determining whether the capacitance change meets a threshold. Various implementations can further include means for initiating a USB host wakeup upon detecting the capacitance change and/or powering the USB interface, such as a USB host controller and/or USB port, upon detecting the capacitance change. Some implementations can include means for generating a wake-up signal upon detecting the capacitance change, receiving the wake-up signal, and initiating a USB host wakeup process upon receiving the wake-up signal. The ‘means for’ in these instances can include (but is not limited to) using any suitable component discussed herein, along with any suitable software, circuitry, hub, computer code, logic, algorithms, hardware, controller, interface, link, bus, communication pathway, etc.

What is claimed is:

1. A universal serial bus (USB) system comprising:
a USB interface; and
a USB capacitive-sensing detection module coupled with a data line of the USB interface, wherein the USB capacitance-sensing detection module is configured to detect a USB plug-in event by monitoring a change in capacitance on the data line.

2. The USB system of claim 1 wherein the USB interface is in a powered-down state, and the USB capacitive-sensing detection module detects a capacitance change on the data line when a USB device is attached to the powered-down USB interface.

3. The USB system of claim 2 wherein the USB interface includes a USB port in a powered-down state, wherein the USB capacitive-sensing detection module detects a capacitance change on the data line when the USB device is attached to the powered-down USB port.

4. The USB system of claim 3 further configured to power up the powered-down USB port upon detecting the capacitance change.

5. The USB system of claim 1 further including a USB host, wherein the USB host is in a standby mode, and further wherein the USB system is configured to wake-up the USB host from the standby mode when the USB capacitive-sensing detection module detects the USB plug-in event.

6. The USB system of claim 5 wherein the USB host includes a USB host processor communicatively coupled with the USB capacitance-sensing detection module, such that the USB host processor is notified when the USB capacitance-sensing detection module detects the USB plug-in event.

7. The USB system of claim 6 wherein the USB interface includes a USB host controller, wherein the USB host processor is coupled to the USB host controller and is configured to power up the USB host controller upon being notified of the USB plug-in event.

8. The USB system of claim 7 wherein the USB capacitive-sensing detection module is on a same integrated circuit chip as the USB host controller.

9. The USB system of claim 1 wherein the USB capacitive-sensing detection module includes a capacitance-to-digital converter.

10. The USB system of claim 9 wherein the USB capacitive-sensing detection module further includes a scaling network coupled with the capacitance-to-digital converter.

11. A method comprising:
monitoring a capacitance on a data line of a USB interface; and
detecting a capacitance change on the data line that indicates a USB plug-in event.

12. The method of claim 11 wherein the detecting the capacitance change on the data line that indicates the USB plug-in event includes determining whether the capacitance change meets a threshold.

13. The method of claim 11 further including generating a wake-up signal upon detecting the capacitance change.

14. The method of claim 11 further including initiating a USB host wakeup upon detecting the capacitance change.

15. The method of claim 11, wherein the USB interface is in a powered-down state, the method further including powering the USB interface upon detecting the capacitance change.

16. The method of claim 15 wherein the powering the USB interface includes supplying power to a USB port of the USB interface.

17. An apparatus comprising:
a USB host that includes:
a powered-down USB port; and
a USB capacitive-sensing detection module coupled with a data line of the powered-down USB port, wherein the USB capacitance-sensing detection module is configured to detect when a USB device is attached to the powered-down USB port.

18. The apparatus of claim 17 wherein the USB host is configured to power up the USB port when the USB capacitance-sensing detection module detects that the USB device is attached to the powered-down USB port.

19. The apparatus of claim 17 wherein the data line is a D+ signal line, a D− signal line, or both the D+ signal line and the D− signal line.

20. The apparatus of claim 17 wherein the USB capacitive-sensing detection module includes a capacitance-to-digital converter.
